(19) United States
(12) Patent Application Publication
(10) Pub. No.: US 2022/0218453 A1
(43) Pub. Date: Jul. 14, 2022

(54) INTERDENTAL CLEANING TOOL

(71) Applicant: JIANGBO MA, Changzhi (CN)

(72) Inventor: JIANGBO MA, Changzhi (CN)

(21) Appl. No.: 17/657,616

(22) Filed: Mar. 31, 2022

Related U.S. Application Data
(63) Continuation-in-part of application No. PCT/CN2019/110642, filed on Oct. 11, 2019.

(51) Int. Cl. A61C 15/04

(52) U.S. Cl. CPC A61C 15/046; A61C 15/045

(57) ABSTRACT

An interdental cleaning tool composed of a U-shaped arch and a handle, which can be used with various types of dental floss. The tool is made of a stainless steel wire, and hence can be used repeatedly. Two ends of the U-shaped arch part of the floss holder are each provided with a ring groove, and the dental floss is wound around the ring grooves to ensure that the dental floss will not come loose. A gap is provided at an end of the handle between two segments of the steel wire of which the handle is made, and the two segments of the steel wire of the remaining part of the handle should be tightly attached together. Following winding, the end of the dental floss is clamped in the gap in the middle of the handle for fixation.

### TECHNICAL FIELD

The present invention relates to the technical field of interdental cleaning, and in particular, can effectively solve the problem of having debris stuck between the teeth and can remove dental plaque.

### BACKGROUND

Common interdental cleaning tools currently available on the market include: boxed dental floss, floss sticks and composite-material floss holders. The recommended flossing technique by manufacturers of boxed dental floss is to wind the floss around the fingers to clean in-between the teeth, the drawback of which is the difficulty in cleaning between the molar teeth at the back. The floss sticks have the following problems: 1. floss sticks are generally made of plastic, and the U-shaped arches thereof made of plastic have insufficient rigidity, such that the dental floss is relatively slack during use, leading to a poor cleaning effect; 2. floss sticks have an F-shaped overall structure, making it very difficult to clean in-between the molar teeth at the back; and 3. floss sticks are products for one time use and is disposed of after use, resulting in resource waste and generation of a lot of hard-to-degrade domestic waste. The composite-material floss holders are too complicated in structure, leaving spaces where impurities or germs may accumulate during long-term use and render the structure difficult to clean and disinfect.

### SUMMARY

The present invention provides an interdental cleaning tool considering the above state of the art.

The technical scheme adopted by the present invention is an interdental cleaning tool including a floss holder and dental floss. The floss holder is made of a stainless steel wire and composed of a U-shaped arch and a handle: the angles between the two arms of the U-shaped arch and the arch bottom, and between the arch bottom and the handle, are both 90 degrees with a rounded transition; each end of the U-shaped arch is provided with a ring groove; and a gap is provided at the distal end of the handle between the two segments of the steel wire of which the handle is made, and the two segments of the steel wire of the remaining part of the handle should be tightly attached together. The dental floss is wound at the ring grooves of the two ends of the U-shaped arch, the winding method including: pressing one end of the dental floss with a thumb at the ring groove of either end of the U-shaped arch, around which winding the dental floss clockwise in 15 turns; tightening the dental floss at the ring groove of the other end of the arch, then winding the dental floss clockwise in 10 turns first; hooking the free end of the dental floss to the dental floss between the two ends of the U-shaped arch; tightening the floss counterclockwise, and then winding it counterclockwise in five or six turns; and after the winding is finished, clamping the end of the dental floss in the gap in the middle of the handle for fixation.

The effect of the present invention is that the interdental cleaning tool of the present invention can be used with various types of dental floss. The floss holder body is made of a stainless steel wire and can be used repeatedly. The interdental cleaning tool has a smooth surface and a high hardness, is simple in structure and easy to clean after use, and can be disinfected at a high temperature. The floss holder is generally Y-shaped with a simple and compact structure, allowing flexible operations at different angles, such that each gap between the teeth can be conveniently cleaned. The U-shaped arch part of the floss holder is made of a stainless steel wire, thereby having a high rigidity, which together with the winding method described herein ensures sufficient tension of the dental floss, such that even food fibers which are wedged tightly between teeth can be easily removed.

### BRIEF DESCRIPTION OF DRAWINGS

FIG. 1 shows a front view of the configuration of an interdental cleaning tool provided in the present invention, and a partial enlargement view at a ring groove.

FIG. 2 is a front view of the interdental cleaning tool after floss winding.

FIG. 3 is a schematic diagram showing the process of floss winding on the floss holder.

FIG. 4 is a schematic top view showing the tightening of the dental floss counterclockwise at a second end of the floss holder.

### DETAILED DESCRIPTION OF EMBODIMENTS

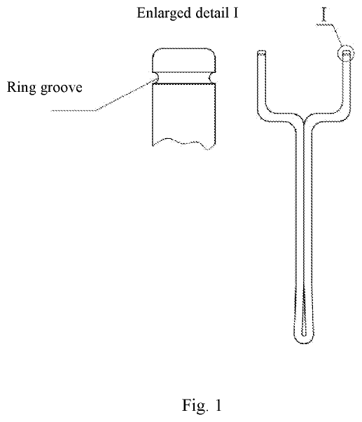

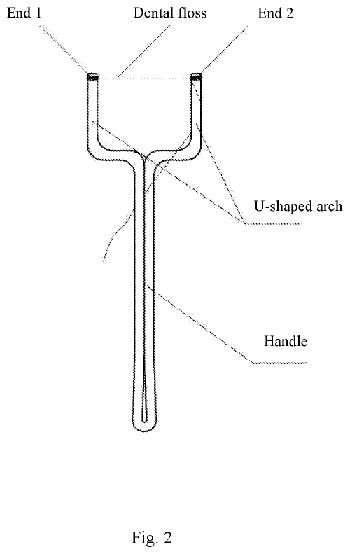

The interdental cleaning tool provided in the present invention is further described herein with reference to the drawings. Referring to FIGS. 1 and 2, the interdental cleaning tool provided in the present invention includes a floss holder and dental floss. The floss holder is made of a stainless steel wire and composed of a U-shaped arch and a handle. The angles between the two arms of the U-shaped arch and the arch bottom, and between the arch bottom and the handle, are both 90 degrees with a rounded transition. Each end of the U-shaped arch is provided with a ring groove. A gap is provided at a distal end of the handle between the two segments of the steel wire of which the handle is made, and the two segments of the steel wire of the remaining part of the handle should be tightly attached together. The dental floss is wound at the ring grooves of the two ends of the U-shaped arch.

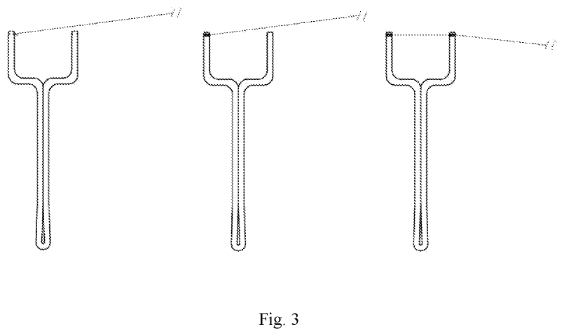

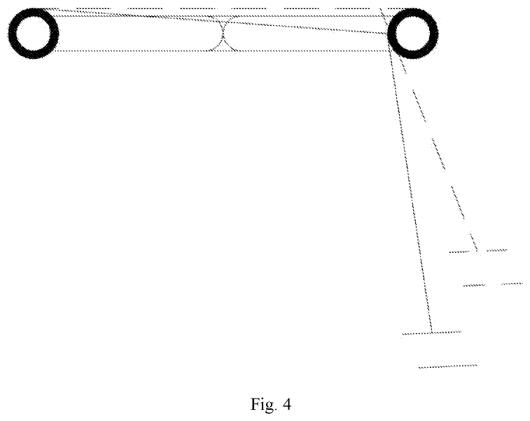

Referring to FIGS. 2-4, the floss winding method includes: breaking off about 40 cm of dental floss, pressing one end of the dental floss with a thumb at the ring groove of either end of the U-shaped arch, around which winding the dental floss clockwise in 15 turns; tightening the dental floss at the ring groove of the other end of the arch, winding the dental floss clockwise in 10 turns first and then, as shown in FIG. 4, hooking the free end of the dental floss to the dental floss between the two ends of the U-shaped arch; tightening the floss counterclockwise from the position indicated in broken lines to the position indicated in solid lines, and then winding it counterclockwise in 5 or 6 turns; and after the winding is finished, clamping the end of the dental floss in the gap in the middle of the handle as shown in FIG. 2.

The interdental cleaning tool of the present invention can be used with various types of dental floss and can be used repeatedly. The interdental cleaning tool has a smooth surface and a high hardness, is simple in structure and easy to clean after use, and can be disinfected at a high temperature. The floss holder is generally Y-shaped with a simple and compact structure, allowing flexible operations at different angles, such that each gap between the teeth can be conveniently cleaned. The U-shaped arch part of the floss holder is made of a stainless steel wire, thereby having a high rigidity, which together with the winding method described herein ensures sufficient tension of the dental floss, such that even food fibers which are wedged tightly between the teeth can be easily removed.

The above is only a preferred embodiment of the present invention, and is not intended to limit the present invention. Any modification, equivalent replacement, improvement, etc. made within the spirit and principle of the present invention shall fall within the scope of protection of the present invention.

1. An interdental cleaning tool, comprising: a floss holder and dental floss wherein the floss holder is made of a steel wire generally in a Y shape and composed of a U-shaped arch and a handle; the dental floss is fixed at two ends of the U-shaped arch by a winding method; the dental floss is tightened with tension during process of winding; and the dental floss is fixed by the handle after winding.

2. The interdental cleaning tool of claim 1, wherein the floss holder is made of a stainless steel wire.

3. The interdental cleaning tool of claim 1, wherein angles between two arms of the U-shaped arch andan arch bottom, and between the arch bottom and the handle, are both 90 degrees with a rounded transition.

4. The interdental cleaning tool of claim 1, wherein each end of the U-shaped arch is provided with a ring groove.

5. The interdental cleaning tool of claim 1, wherein a gap is provided at a distal end of the handle between two segments of the steel wire of which the handle is made, and the two segments of the steel wire of the remaining part of the handle should be tightly attached together.

6. The interdental cleaning tool of claim 1, wherein the dental floss is fixed at the ring grooves of the two ends of the U-shaped arch by means of winding.

7. The interdental cleaning tool of claim 1, wherein the winding method is a tensioning, and winding method and an end of the dental floss is fixed by a gap in the middle of the handle, the winding process comprising: pressing one end of the dental floss with a thumb at the ring groove of either end of the floss arch, winding the dental floss clockwise in multiple turns, then tightening the dental floss at the ring groove of the other end of the arch, winding the dental floss clockwise in multiple turns first and then hooking a free end of the dental floss to the dental floss between the two ends of the U-shaped arch, tensioning the dental floss counterclockwise, and then winding the dental floss counterclockwise in multiple turns, and following winding, clamping the end of the dental floss in the gap in the middle of the handle for fixation.
